(19) United States
(12) Patent Application Publication
(10) Pub. No.: US 2019/0180658 A1
(43) Pub. Date: Jun. 13, 2019

(54) ADVERTISING METHODS WITH RE-CONFIGURABLE BEVERAGE SLEEVE

(71) Applicant: Hermes Innovations, LLC, Cupertino, CA (US)

(72) Inventor: John H. SHADDUCK, Menlo Park, CA (US)

(73) Assignee: Hermes Innovations, LLC, Cupertino, CA (US)

(21) Appl. No.: 15/839,590

(22) Filed: Dec. 12, 2017

(51) Int. Cl. G09F 23/00; A47G 23/02; G09F 23/14

(52) U.S. Cl. CPC G09F 23/0091; G09F 2023/0025; G09F 23/14; A47G 23/0216

(57) ABSTRACT

Combination devices that are adapted for marketing and promotion and use a sleeve for insulating beverage containers that is transformable into a toy module, building block, and/or geometric shape.

### FIELD OF THE INVENTION

The present invention is directed toward combination devices that are adapted for marketing and promotion and use a sleeve for insulating beverage containers that is transformable into a foldable toy or building block.

### DESCRIPTION OF THE RELATED ART

Insulating beverage sleeves for coffee cups and soft drinks are well known. The market for specialty coffees has experienced tremendous growth in recent decades. There are now 20,000 specialty coffee stores in the U.S. which generate $10 billion in annual revenue, with one leading coffee provider serving 10,000,000 cups of coffee per day. As many as 20% of the U.S. population purchases specialty coffee on a daily basis. In the field of soft drinks, Coca Cola reports that it sells 1.8 billion drinks per day, a significant percentage of which is sold in aluminum cans.

The majority of specialty coffees are served in paper cups with a disposable paper “coffee sleeve” provided for thermal insulation. Coffee sleeves have been continuously improved by using recyclable materials to minimize the overall environmental footprint created by using such sleeves, but the sheer volume of disposable coffee sleeve still produces significant waste that is destined for landfills.

Coffee sleeves and thermally insulating beverage sleeves in general have become a new platform for marketing and promotion. An industry report estimates that the average cup of coffee purchased at a specialty coffee retailer is held for 45 minutes by the customer and is seen by seven individuals. This makes coffee sleeves an exceptionally good tool for advertising and promotion.

### SUMMARY OF THE INVENTION

In one aspect, the thermally insulating sleeve of the invention is non-disposable and thus provides an eco-sensitive solution to disposable coffee sleeves. The sleeve corresponding to the invention is a combination product which is reconfigurable from a thermal insulating sleeve to a modular toy that may be used for extended periods of time by the consumer and his or her successive generations. At the same time, the inventive sleeve allows for a first form of advertising to a first set of viewers in the “insulating sleeve” configuration and for a second form of advertising to a second set of viewers in the “toy” configuration.

The present disclosure includes methods for dissemination of information and/or for advertising. Such methods can include business methods or methods for distributing information, advertising, selling, etc. In one example such a method includes providing an advertising construct comprising a beverage container having a sleeve shape that is configured to be transformable from the sleeve shape into a geometric shape having at least one coupling portion on a surface of the geometric shape such that a second advertising construct can be coupled thereto; wherein the advertising construct carries at least one visual image visible on either the sleeve shape and/or on the geometric shape; and distributing the advertising construct to at least one viewer, such that the viewer can view the at least one visual image when in either the sleeve shape or the geometric shape. The construct can have many forms including but not limited to an insulator when in use as a beverage sleeve.

The geometric shape can form a modular toy and where viewers can view at least one visual image when in use as the modular toy. In certain variations, a first visual image is viewable when in use as a beverage sleeve and a second visual image is viewable when in use as a modular toy.

Variations of the methods and devices can include the geometric shapes comprising a building block or any other polyhedral type object. The visual images can comprise at least one of a name, logo, image, trademark, tag line, color arrangement, symbol, letter, website address, numerical message, puzzle, text message, hashtag or cryptogram.

In certain variations, the construct is transformable from the sleeve shape configuration to the geometric shape by of at least one of detaching, assembling, folding, bending, fastening and/or coupling elements to one another.

In another variation, the present disclosure includes a combination device. For example, such a combination device can include a toy and insulator sleeve for a beverage container, comprising a construct for positioning around an outer surface of the beverage container, wherein at least a portion of the construct comprises a modular toy configured to couple to a second modular toy. The combination device can include variations where the insulator sleeve has an exterior surface that carries at least one image. Alternatively, or in addition, the modular toy can include an exterior surface that carries at least one image.

In certain variations, the modular toy includes engagement features for engaging the second modular toy. The construct and modular toy can be formed of at least one of a paper material, a plastic material and a plasticized paper material.

The construct can be transformable from the insulator sleeve configuration to the modular toy configuration by of at least one of detaching, assembling, folding, bending, fastening and/or coupling elements to one another.

In additional variations, the construct includes a plurality of components that are reconfigurable into the modular toy. Alternatively, or in combination, the construct includes at least one component that can be coupled with at least one component from another construct to provide the second configuration.

Another variation of the present disclosure includes a toy building block. For example such a toy building block can include a polyhedron shaped body having a first surface having at least one projecting stud and a second surface with space for receiving at least one stud from a similar body; wherein the polyhedron shaped body is configured from at least one component having a flat shape.

As noted herein, the toy building block can include an image on the body and can be re-configured at least in part by folding to provide the polyhedron shaped body. Additionally, the component can include a nesting element for coupling components together.

The present disclosure also includes methods for distributing information to consumers. Such a method can include providing a message carrying construct, where the message carrying construct is transformable between a beverage container sleeve configuration and a modular geometric configuration; and distributing the message carrying construct to a consumer for use with a beverage container where the message carrying construct carries information on a surface visible in either the beverage container sleeve configuration or the modular geometric configuration.

A variation of the method includes where the message carrying construct comprises a plurality of edges and at least one deformable hinge, and in the beverage sleeve configuration at least two edges of the message carrying construct are removably connectable to form the beverage container sleeve configuration and where in the modular toy configuration at least two of the plurality of edges are removably connectable and the deformable hinge is deformable to form the modular geometric configuration, where the message carrying construct further comprises a plurality of nesting elements to couple with a second message carrying construct.

In an additional variation, the disclosure includes variations of beverage containers. For example a beverage container according to the present application can include a panel being configurable to form at least a sleeve configuration; an identifiable image located on the panel; at least one geometric component being detachably affixed to the panel; and where in the sleeve configuration the panel is configured to receive the beverage container, and an exterior surface opposite to the beverage container having the identifiable image.

In an additional variation, the beverage container includes one of the at least one geometric components comprising a second identifiable image.

The at least one geometric component can have at least one nesting element for coupling to another geometric component. In an additional variation, the at least one geometric component comprises a plurality of geometric components, where on detachment from the panel, the plurality of geometric components are adapted to couple to at least one other geometric component at their respective nesting elements to form a polyhedron shaped object.

The polyhedron shape described herein can include such shapes as a block, a cube, a pyramid, a toroid, and a diamond. In additional variations, the geometric component, construct and/or panels can include a reservoir containing a substance that is configured to cool or heat the beverage container.

In additional variations, the substantially cylindrical shape comprises a shape selected from a frustum shape, a cylinder shape, and a prism shape.

In another variation, the present disclosure includes one or more beverage container covers comprising: a plurality of panels being configurable between at least a sleeve configuration and at least a polyhedron shape, where the plurality of panels includes at least one hinge separating adjacent panels; an identifiable image located on at least one panel; at least a first nesting element located on at least one panel, where the first nesting element is adapted to engage a second nesting element; where in the sleeve configuration the plurality of panels maintain a substantially cylindrical shape having an interior surface that is configured to slidably engage the beverage container, and an exterior surface opposite to the beverage container having the identifiable image; and where the at least one hinge is deformable such that at least a first edge of a first panel and at least a second edge of a second panel can be coupled transforming the plurality of panels into the polyhedron shape with the identifiable image being visually observable from an exterior of the polyhedron shape.

Variations of the beverage container include at least one detachable component being adapted to couple to the polyhedron shape when detached from the plurality of panels. Additional variations allow for the polyhedron shape comprises a shape selected from a group consisting of a block, a cube, a pyramid, a toroid, and a diamond.

In yet an additional variation, the beverage container can include a second nesting element that is located on a second beverage container configured in a second polyhedron shape, where the first and where coupling the second nesting elements together couples the beverage container in the polyhedron shape with the second beverage container in the polyhedron shape.

In a first aspect, the invention provides a business method for advertising and includes providing an advertising construct consisting of a beverage container having a sleeve shape that is transformable from the sleeve shape into a geometric shape having at least one coupling portion on a surface of the geometric shape such that a second advertising construct can be coupled thereto. The advertising construct carries at least one visual image visible on either the sleeve shape and/or on the geometric shape and the business method includes distributing the advertising construct to at least one viewer, such that the viewer can view the at least one visual image when in either the sleeve shape or the geometric shape.

In a second aspect, the invention comprises a polyhedron shaped body having a first surface having at least one projecting stud and a second surface with space for receiving at least one stud from a similar body wherein the polyhedron shaped body is configured from at least one component having a flat shape. Additionally, the components can be assembled on a thin panel and formed into a sleeve for a beverage container that at least one advertising message.

In a third aspect, the invention comprises a beverage container cover having a thin panel that is configurable to form at least a sleeve configuration with an identifiable advertising image located on the panel. Further, at least one geometric component is detachably affixed to the panel which comprises a modular toy.

In another variation, the present disclosure describes devices for use with a beverage container. For example, such a device can include a construct configured to form a sleeve shape for positioning about the beverage container, the construct having a first side, a second side, and a support portion; a first graphical image on the first side of the construct, where in the sleeve shape the first side engages the beverage container, when placed thereon, causing the first graphical image to be obscured from view, while the second side faces away from the beverage container allowing for engagement by a user during handling of the beverage container; and when in the sleeve shape, the support portion of the construct can be deformed or detached from a remainder of the construct transforming the sleeve shape into a self-supporting structure to transform the construct from the sleeve shape to a display shape that allows for display of the first graphical image.

Variations of the device can further comprise a second graphical image located on the second side, where the second graphical image can be viewed during handling of the beverage container.

In another variation, the device further comprises a second graphical image on the second side of the construct, where the display shape allows for display of the first graphical image and the second graphical image simultaneously.

The display shape can be any shape, including but not limited to a toy form.

The first graphical image comprises a plurality of first graphical images. Such images can be detachable from the construct and configured to be joined to the display shape.

The support portion of the construct is entirely removable from the construct.

In one variation, the construct must be disassembled from the sleeve shape prior to deforming or detaching the support portion from the construct. In alternate variations, the construct is configured to remain in the sleeve shape prior to and after deforming or detaching of the support portion from the construct.

The construct can comprise a thermally insulating material.

Variations of the device can include graphical images selected from a group consisting of a picture, name, initials, logo, image, trademark, tag line, color arrangement, symbol, letter, address, website, numerical message, text message, hashtag, puzzle and cryptogram.

The present disclosure also includes methods for conveying information with or to a consumer. For instance, the method can include providing a sleeve construct for positioning about a beverage container such that a first side of the construct engages the beverage container, and a second side of the sleeve construct is opposite to the first side and allowing for engagement by the consumer during handling of the beverage container, where the first side comprises a first graphical image, and where the second side comprises a second graphical image; and positioning the sleeve construct about the beverage container such that the first graphical image is obscured by the beverage container and the second graphical image is not obscured by the beverage container until the consumer modifies at least a portion of the sleeve construct and deforms or detaches a portion of the sleeve construct from a remainder of the sleeve construct to form a self-supporting display shape that allows for viewing of the first graphical image.

The first graphical image can be different from the second graphical image. The method can include a sleeve construct that is configured such that modifying the thin material includes at least one of the steps of detaching, folding, bending, cutting or assembling said material or a portion thereof. The first graphical image and the second graphical image can be selected from a group consisting of: a picture, name, initials, logo, image, trademark, tag line, color arrangement, symbol, letter, address, website, numerical message, text message, hashtag, puzzle and cryptogram.

In another variation, the method can include comprise providing a sleeve construct for positioning about a beverage container such that a first side of the construct engages the beverage container, and a second side of the sleeve construct is opposite to the first side and allowing for engagement by the consumer during handling of the beverage container, where the first side comprises a first graphical image, and where the second side comprises a second graphical image; positioning the sleeve construct about the beverage container such that the first graphical image is obscured by the beverage container and the second graphical image is not obscured by the beverage container; modifying at least a portion of the sleeve construct by deforming or detaching a portion of the sleeve construct from a remainder of the sleeve construct to form a self-supporting display shape to allow for viewing of the first graphical image.

### BRIEF DESCRIPTION OF THE DRAWINGS

FIG. 1 is a side view of a reconfigurable sleeve according to one illustrated embodiment, in use on a beverage container such as a paper coffer cup showing an advertisement or visual image on an exterior surface.

FIG. 2 is a sectional view of the reconfigurable sleeve of FIG. 1 taken along line 2-2 of FIG. 1.

FIG. 3 is a plan view of the reconfigurable sleeve of FIG. 1 in an as-formed, flat configuration wherein the sleeve is formed or molded of a thin material with the view showing fold lines, bend lines, detachment lines and an adhesive line.

FIG. 4 is a sectional view of the reconfigurable sleeve of FIG. 3 taken along line 4-4 of FIG. 3.

FIG. 5 is another view of the reconfigurable sleeve of FIGS. 1 and 3 in a folded, flat configuration for shipping and storage.

FIG. 6A is view of the reconfigurable sleeve of FIGS. 1 and 3 with the detachable elements of the toy configuration detached from as-formed, flat configuration of the sleeve of FIG. 3, wherein the illustrated embodiment includes three detachable elements that are assembled to form the toy configuration.

FIG. 6B is view of the three detachable elements of FIG. 6A is the process of being assembled to form the toy configuration of the sleeve.

FIG. 6C is another view of the three detachable elements of FIGS. 6A-6B after of being assembled to form the toy configuration with the advertisement on its exterior surface.

FIG. 6D is view of several building blocks in the form of FIG. 6C that each have protruding studs and stud-receiving openings for constructing walls, etc.

FIG. 7 is a cut-away view of a snap-fit feature of one illustrated embodiment for securely assembling the three detachable elements into the robust toy building block of FIGS. 6C-6D.

FIG. 8 is a side view of another variation of a reconfigurable thermally insulating construct in use on a beverage container such as an aluminum can showing a first advertisement on an exterior surface.

FIG. 9A is a view of the reconfigurable sleeve of FIG. 8 that comprises a detached part of the construct of FIG. 9B and can be folded into a toy block, the detached part shown in an as-formed, flat configuration

FIG. 9B is a view of the construct that forms the insulating sleeve of FIG. 8 showing detachment lines for detachment of the component of FIG. 9A.

FIG. 10 is a view of the detached component of FIG. 9 after folding into a toy block, wherein the illustrated embodiment consists of a single component that can be assembled into the toy block configuration.

FIG. 11A is a view of another variation of a reconfigurable coffee sleeve with multiple molded elements combined with a thin detachable backing material, the variation shown in a flat configuration.

FIG. 11B is a perspective sectional view of the transformable beverage container sleeve of FIG. 11A in use on a paper coffee cup showing an advertisement on an exterior surface.

FIG. 11C is a sectional view of a building block that is assembled from the multiple molded elements of FIGS. 11A-11B, the sectional view taken along line 11C-11C of FIG. 11D.

FIG. 11D is a perspective view of a building block assembled from the elements of FIG. 11A together with an advertisement.

FIG. 12A is a view of a portion of another variation of a coffee sleeve with a plurality of building blocks provided by the sleeve, wherein the sleeve carries an advertisement on its exterior surface.

FIG. 12B is a perspective view of the coffee sleeve of FIG. 12A in use on a paper coffee cup showing an advertisement on an exterior surface.

FIG. 12C is a perspective view of a single building block as provided by the assembly of FIG. 12A.

FIG. 12D is a view of a portion of the building block of FIG. 12C showing features for receiving the projecting stud of another building block.

FIG. 12E is a view of a plurality of building blocks as in FIG. 12C assembled into a wall showing an advertisement.

FIG. 13 is a view of a portion of another variation of an advertising construct with a plurality of building blocks carried by the construct, with each block having a visual image for advertising.

FIG. 14 is a view of the construct of FIG. 13 in the sleeve shape with an exterior surface of the construct carrying another visual image for advertising.

FIG. 15A is a view of another variation of a message carrying construct with a visible, first or exterior surface of the construct in a first beverage sleeve form carrying first information comprising a logo and visual image for advertising purposes.

FIG. 15B is a view of the opposite side of the message carrying construct of FIG. 15A showing a foldable figurine and accessories in such a second surface carrying second information comprising foldable toy with a logo for advertising purposes.

FIGS. 15C and 15D show an example of assembled display shapes.

FIG. 16A is a view of another variation of a message carrying construct having a visible, first surface in a first beverage sleeve form carrying first information comprising a logo for advertising purposes.

FIG. 16B is a view of the opposite side of the message carrying construct of FIG. 16A showing a foldable automotive vehicle in a second surface carrying second information in the form or a visually identifiable care design and manufacturer logo.

In the drawings, identical reference numbers may identify similar elements or features. The sizes and relative positions of elements in the drawings are not necessarily drawn to scale. Further, the particular shapes of the elements as drawn, are not intended to convey information regarding the actual shape of the particular elements, and have been drawn to allow for ease of recognition and understanding of the elements.

### DETAILED DESCRIPTION OF THE INVENTION

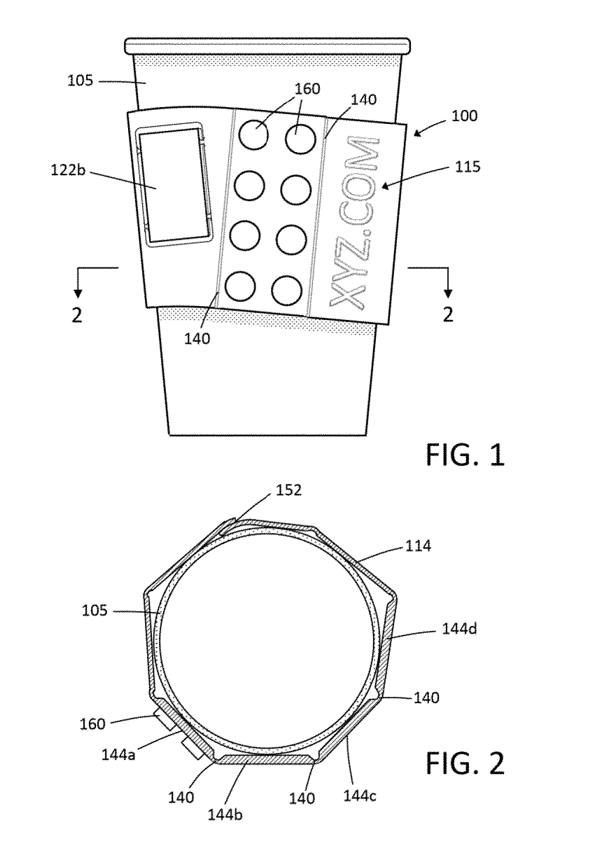

The present invention is directed toward marketing and promotion methods utilizing thermally insulating sleeves for beverage containers that are adapted to advertise to a first set of viewers who observe the sleeve at the time of a beverage sale and then advertise to a second set of viewers who view the sleeve after its transformation into a toy. The invention is further directed toward variations of reconfigurable devices and systems that first provide an insulating sleeve for a beverage container and secondly provide a toy such as a building block. Various embodiments of a reconfigurable sleeve are described in detail herein. Several details of certain embodiments are set forth in the following description and illustrated in FIGS. 1-11 to provide an understanding of those embodiments. One skilled in the art will understand that the teachings herein will make apparent additional embodiments or features, and may be practiced without several of the details described in the following description and illustrated in the figures. A beverage container can include paper, plastic, aluminum and glass containers or the like.

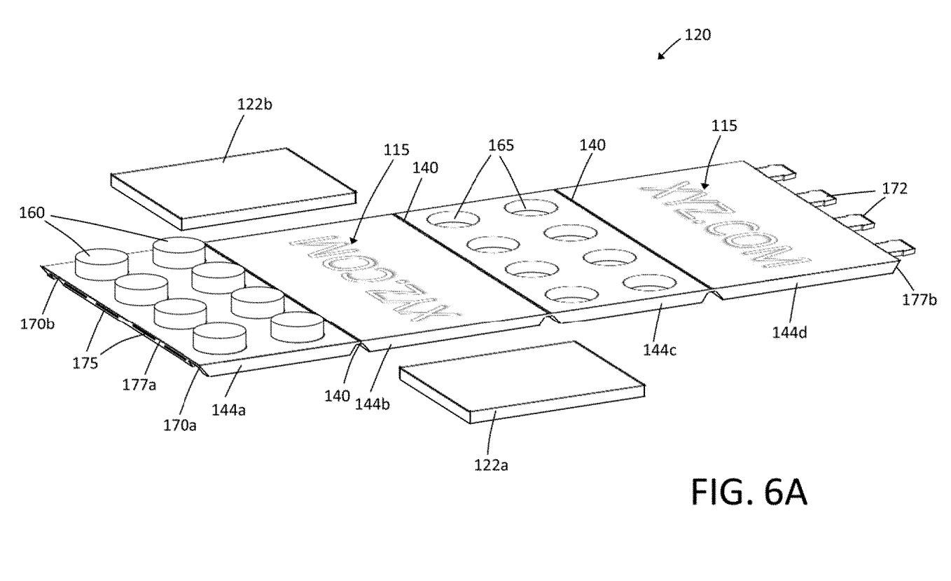

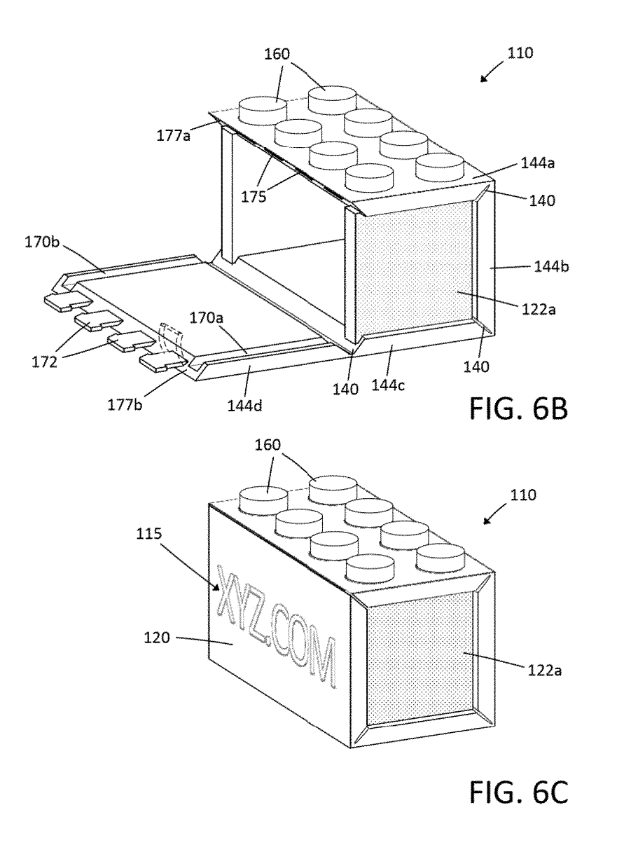

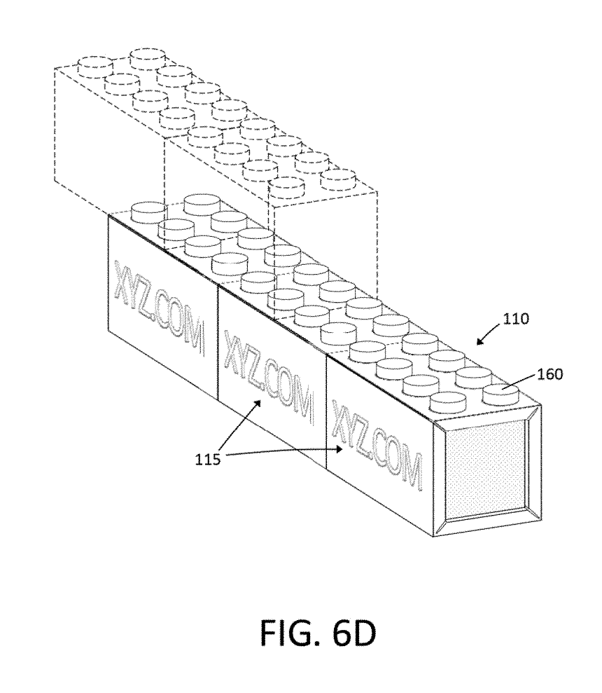

FIG. 1 illustrates a device or advertising construct 100 corresponding to the invention in a first configuration that functions as an insulating sleeve positioned around a beverage container 105 such as a disposable coffee cup. The transverse sectional shape of the construct 100 can be seen in FIG. 2 and can be designed to accommodate beverage containers of various dimensions. The construct 100 can slide into position on the cup, and can have a vertical dimension relative to the beverage container of about 1″ to 4″ or more. As can be seen if FIG. 1, the walls of the advertising construct can have any suitable thickness and have adaptations described in detail below that allow it to be reconfigured into a geometric shape such as a modular toy or building block 110 as shown in FIGS. 6A-6D.

In FIG. 1, it can be seen that at least one advertisement or visual image 115 is provided on the surface of the advertising construct 100 that is viewable in the sleeve configuration of FIG. 1. The term advertisement as used herein can encompass any text or feature that is useful for marketing and promotion, and can include but is not limited to at least one of a name, logo, photographic image, trademark, color arrangement, symbol, website address, numerical message, text message, message portion, letter, number, script, musical note, hashtag, cryptogram or the like.

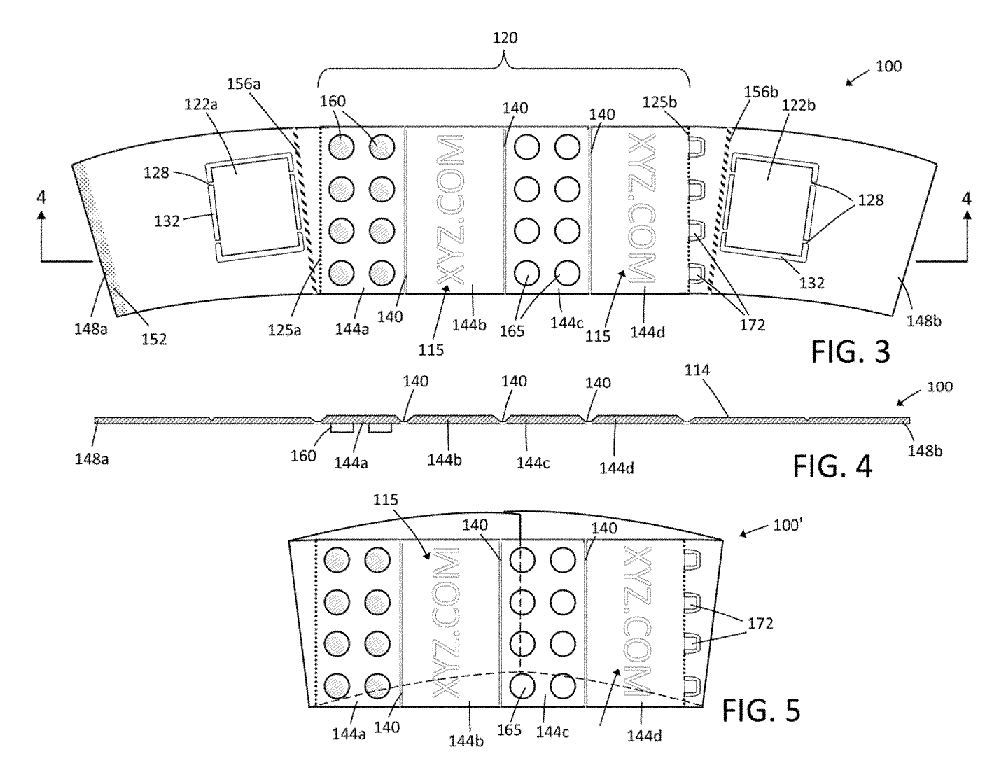

Now turning to FIGS. 3 and 4, the construct 100 can be manufactured or formed into a substantially flat shape, for example, by injection molding, rolling, pressing, stamping or any combination thereof to provide a relatively thin, flat material 114 which still can be flexed or bent to position around a beverage container. The construct 100 can be formed of any suitable material such as plastic, paper, plasticized paper or a combination thereof. In one embodiment, referring to FIG. 3, the construct 100 has detachable elements or components 120, 122a and 122b that together can be assembled and reconfigured into the toy building block 110 of FIGS. 6C-6D. In FIG. 3, the component 120 is detachable from the remainder of construct 100 along detachment lines 125a and 125b. These detachment lines 125a and 125b can be perforations that allow for tearing the element 120 apart from the remainder of the construct 100. Alternatively, the detachment lines 125a and 125b can be cut lines that can be cut with a scissors or knife. The other detachable components 122a and 122b which are the ends of the toy building block 110 of FIGS. 6B-6C are detachable by break-away tabs 128 that extend across molded openings 132 that surround around each component 122a and 122b as is known in the art of molding plastic parts. In one variation as can be seen in FIGS. 3, 4 and 6A, the construct 100 has thin hinge portions or weakened lines 140 along which the material can be hinged or bent to be adapted into the toy block 120 of FIGS. 6B-6C. In one embodiment, between the weakened hinge lines 140, the material that forms the four surfaces 144a-144d of a toy building block 110 of FIGS. 6B-6C can be thicker and substantially flat and not easily bendable.

FIGS. 3 and 5 show that the advertising construct 100 after forming can have its ends 148a and 148b attached along adhesive line 152 to provide a flattened sleeve for storage and transport before being opened and positioned around a coffee cup. The ends 148a and 148b can be bonded together by any suitable means such as adhesives, melt bonding, interlocking slots and features, snap-together fittings, stitching and the like. In FIG. 3, the fold lines 156a and 156b indicate where the construct 100 is folded to provide the flattened circular sleeve 100′ of FIG. 5.

Now turning to FIGS. 3, 4, 6A and 6B, additional features of the detachable component 120 can be seen that relate to the toy configuration of the invention. It can be seen that the modular toy includes coupling features for coupling one modular toy to another modular toy. In one variation, the toy block has at least one stud 160 disposed on surface 148a that is insertable into a receiving opening 165 of opposing surface 148c of a similar block when component 120 is reconfigured into the block 110 of FIGS. 6B-6C. In the variation of FIGS. 6A-6C, the building block has eight studs, but the number of studs can range from 1 to about 50. The studs can be round, rectangular or have a polygonal cross-section and can have mean diameter of between 1 mm and 10 mm. The length, width and height of the toy block obviously can be any suitable dimensions that fit with the form factor of a beverage sleeve. Although the variation shown in FIGS. 1-6C shows one building block per construct, it can be understood that a plurality of toy blocks could be formed into the form factor of a single beverage sleeve. Additionally, a set of beverage sleeves can be provided wherein different sleeves can carry different sizes or types of building blocks to allow the consumer to acquire a “set” of toy building blocks. In another variation, the block dimensions, studs and stud spacing can be selected to cooperate and interface with other commercially available toy blocks, such as Lego® blocks, Meccano® blocks or other similar sets of blocks.

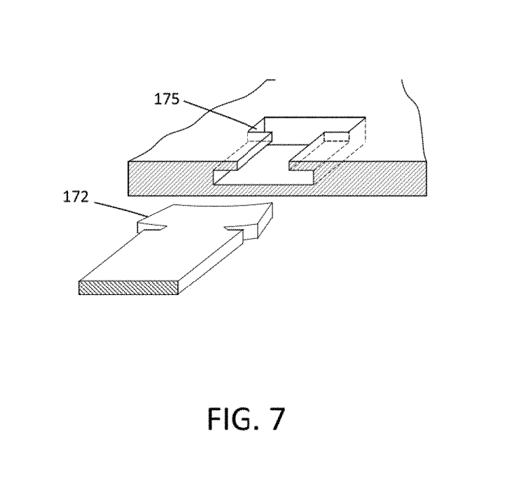

In one variation shown in FIGS. 6A-6B, the modular toy is a polyhedron shaped body that in one variation is toy block 110 that can be assembled from the three detachable components. The larger component 120 is progressively hinged or folded along hinge lines 140 and the end components 122a and 122b are fitted into grooves 170a and 170b. In FIG. 6B, it can be seen that molded, bendable snap-fit elements 172 are adapted to be inserted into molded receiving slots 175 to permanently hold the edges 177a, 177b of surfaces 144a and 144d together to make the toy block. FIG. 7 shows an enlarged view of one variation of such snap-fit elements 172 and 175 of a type which can be injection molded. It should be appreciated that any suitable engaging elements at edges 177a and 177b can be used to form the toy block 110, including adhesives, pins, slide lock elements, thermal bonds and the like. The advertising construct 100 further could include a heat shrink material or a shape memory polymer that can be used to lock the surfaces in the form of the toy building block, wherein such materials could be heated by an oven, hair dryer or the like after assembly into the building block configuration of FIG. 6C.

In one aspect of the invention, the toy block (FIG. 6C) comprises a polyhedron or box shaped body having a first side having at least one projecting stud 160 and a second opposing side with space for receiving at least one stud from a similar body, wherein the polyhedron shaped body is configured from at least one component having an initial non-box shape. The initial non-box shape is substantially planar as shown in FIG. 6A.

FIG. 6D illustrates a plurality of toy blocks 110 being assembled into a wall wherein the advertisement 115 is permanently shown on the sides of the assembled block to reach a second set of viewers.

In one aspect, a business method of the invention for advertising comprises providing a construct carrying an advertisement that is transformable from a first beverage container sleeve configuration (FIG. 1) to a second toy configuration (FIG. 6C), and distributing the construct so that viewers are able to view at least one advertisement in the both the first and second configurations.

In an example, a consumer first purchases a beverage with the advertising construct 100 or sleeve disposed around the beverage container and the advertisement 115 (see FIG. 1) is viewed by a first set of viewers. Thereafter, the consumer does not dispose of the sleeve but instead provides the construct 100 to his children who adapt it into a toy building block 120 and the advertisement 115 is then permanent and may be viewed over an extended time period by a second set of viewers (see FIG. 6D).

In another aspect of the invention, a business method comprises providing a construct 100 carrying at least one advertisement that is adapted for first, second and third configurations, wherein the first configuration is flat to reduce volume for shipping, storage and/or display, the second configuration is non-flat for positioning around a beverage container, the third configuration is reconfigured into a toy, and thereafter distributing the construct wherein viewers are exposed to the advertisement in the second and/or third configurations.

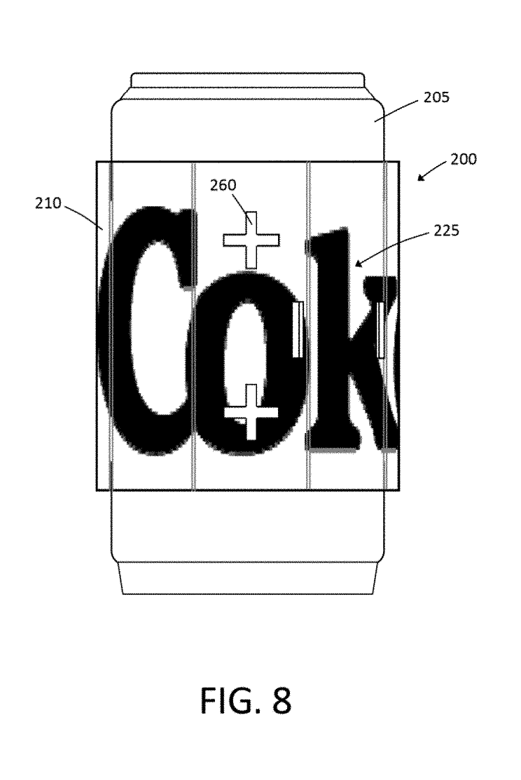

FIGS. 8-11 illustrate another variation of advertising construct that comprises an insulating beverage sleeve 200 positioned around an aluminum beverage can 205. In this embodiment, the sleeve 200 again can be paper, cardboard, plastic or any combination thereof and can be manufactured and potentially can be formed more easily than the variation of FIGS. 1-6C. The variation shown in FIG. 8 can consist of a single component 210 that is re-configurable by only folding into a toy building block 220 as shown in FIG. 10. This variation also is depicted with a first advertisement 225 being viewable on the sleeve 200 in the first beverage sleeve configuration (FIG. 8) and a second advertisement 225′ being viewable in the second toy block configuration (FIG. 10).

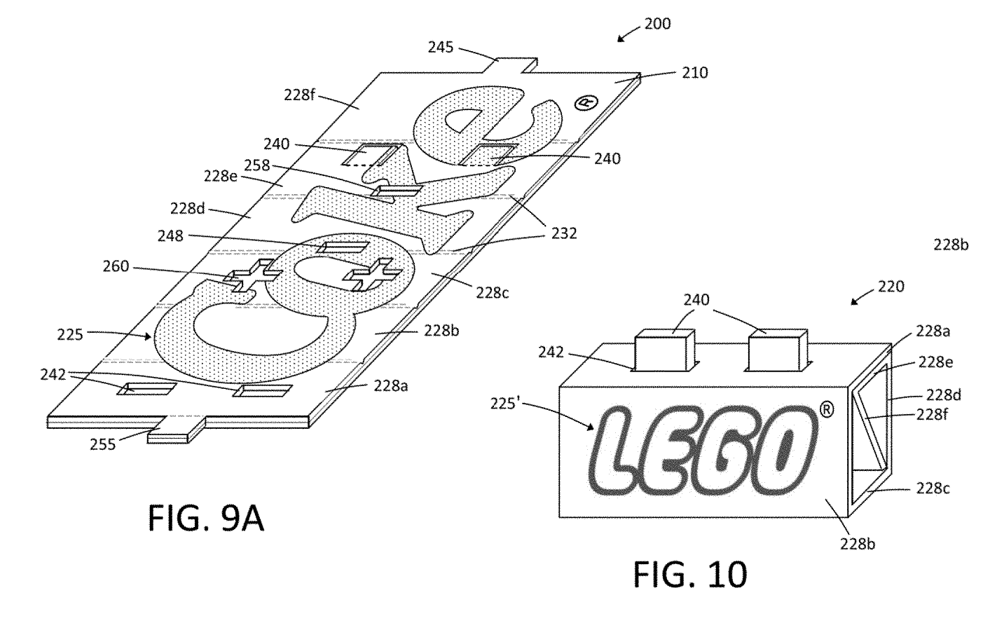

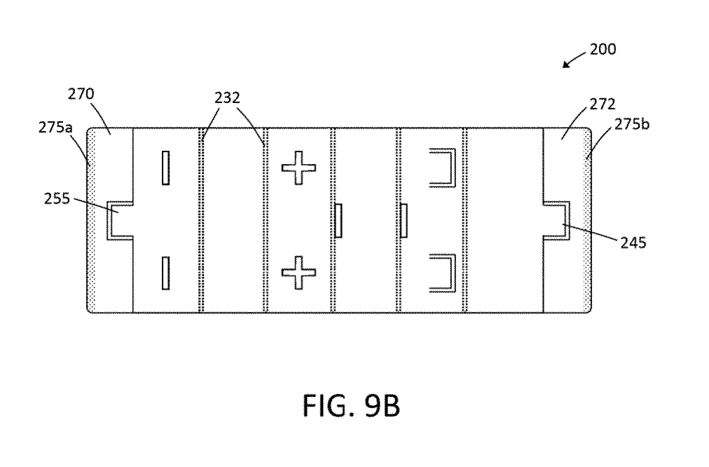

In an example of a business method and opportunity using a beverage sleeve with different advertisements in the different configurations, referring to FIGS. 8-10, Coca Cola® could advertise with its logo on the first surface of the construct 200 when used with the beverage container, but then could sell the advertising rights for the second surface of the sleeve to a third party who was more interested in promoting and marketing to users and viewers of the toy configuration. For example, Lego® could be interested in its logo being displayed in the toy configuration to promote its full product line to users of the toy block configuration. The sleeve of FIGS. 8-9 can be positioned on soft drink cans at the time of manufacture, or such sleeves can be flattened and marketed along with packages of such soft drinks. It should be appreciated that the embodiment of FIGS. 1-6C could also be adapted to have different advertisements on the two different sides of construct 100.

In FIG. 9A, it can be seen that the construct 200 is formed with six flat surfaces 228a-228f with weakened fold lines 232 between the surfaces. In this variation, the studs or projecting elements 240 are folded-out from the original flat surface 228d and are adapted to project through openings 242 in surface 228a (see FIGS. 9A and 10). The flat surface 228f is adapted as a diagonal element to add stiffness to the toy block 220. The tab 245 on block 228f is inserted into opening 248 at the intersection of surfaces 228c and 228d. The tab 255 on block 228a is bent and inserted into opening 258 at the intersection of surfaces 228d and 228e to lock the pieces together. The x-shaped openings 260 in surface 228c are adapted to receive the projecting elements 240 from a second block when aligned with the first block or positioned at 90° to the first block to build corners into a wall of toy blocks.

FIG. 9B shows one variation in which the sleeve 200 of FIG. 9A is detachable from end portions 270 and 272 that can extend around a beverage container and be bonded along lines 275a and 275b as described in the previous embodiment of FIG. 3.

The embodiments shown in the drawing indicate that a toy block can be assembled from a single component or a plurality of components that are detachable from a beverage sleeve. In another embodiment (not shown), a toy block can be assembled from a plurality of components that each are provided by a different beverage sleeve.

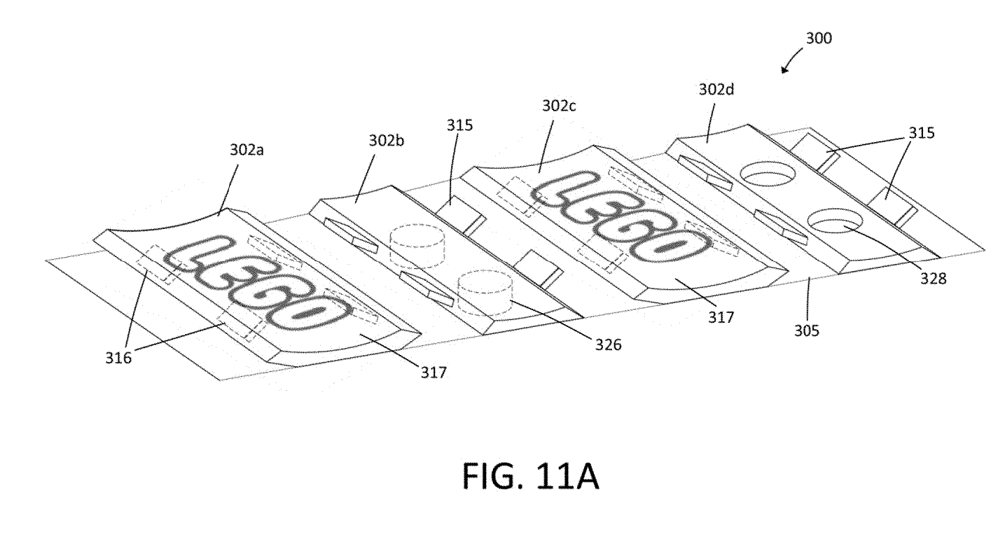

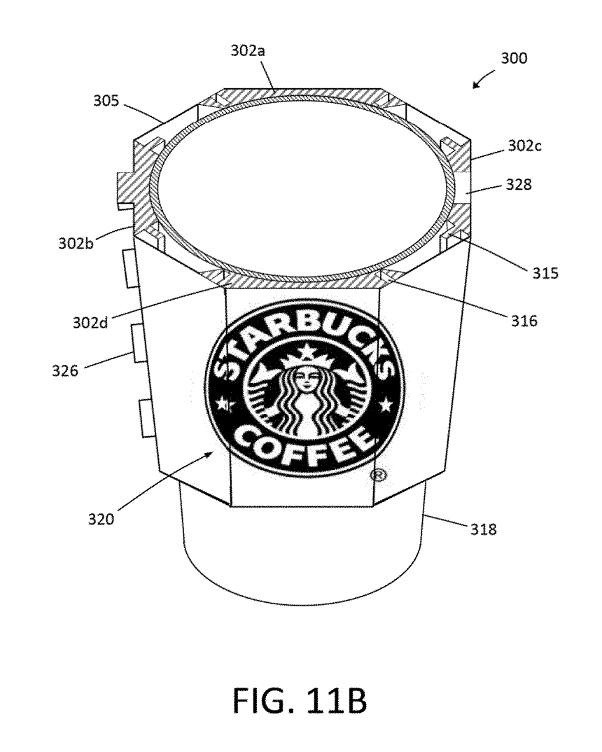

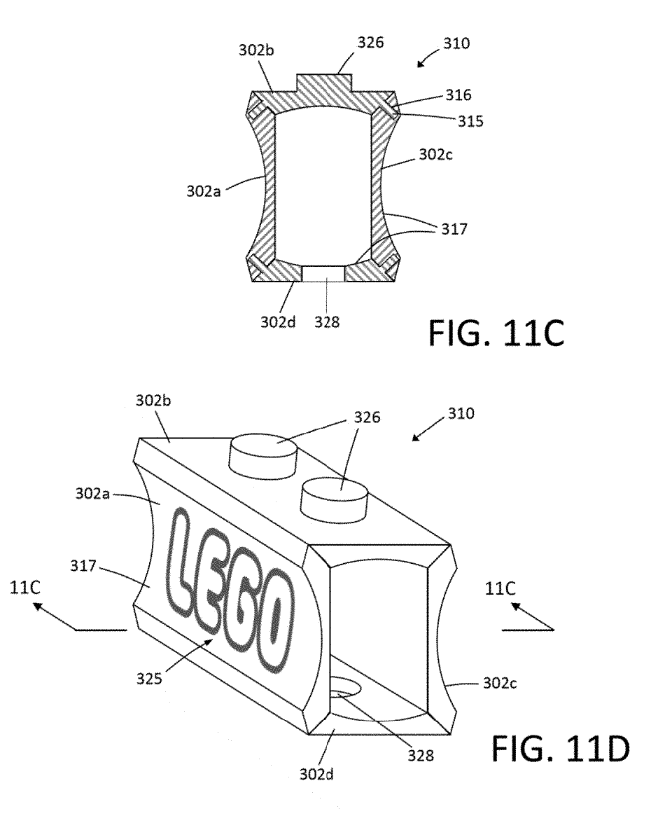

Another variation of transformable sleeve 300 is shown in FIG. 11A, wherein a plurality of molded elements 302a-302d that can be assembled into a toy block are combined with a thin detachable panel or backing material 305 to provide a coffee sleeve. The components are illustrated in FIG. 11A in a flat configuration before being adapted into the coffee sleeve 300 configuration shown in FIG. 11B. As can be understood from previous embodiments, the opposing ends of the thin panel 305 can be adhered to provide the cylindrical form of the sleeve 300 shown in FIG. 11B. In this variation, four elements 302a-302d consist of the four sides or subcomponents of a modular toy or building block 310 and can be detached from thin panel 305 and then be assembled into the toy block 310 of FIG. 11D. The elements 302a-302d can be injection molded from a plastic material and then coupled to a panel 305 which can be paper or plastic. In one variation shown in FIGS. 11A-11C, it can be seen that elements 302a-302d have cooperating engaging elements or nesting elements along edges thereof to allow snap-fit assembly into a robust building block 310 as in FIG. 11D. In the variation shown in FIGS. 11A-11C, the nesting elements consist of projecting tabs 315 and receiving slots 316, but it should be a appreciated that slide-together elements and grooves and other similar features could be used to couple elements together. Similarly, adhesives with peel-away coverings that cover adhesives could be used to provide robust connections between multiple elements to provide the building block as shown in FIG. 11D.

The variation of beverage container sleeve shown in FIGS. 11A-11B includes molded elements 302a-302d that have a curved surface 317 for mating generally with the surface of a tapered or cylindrical coffee cup or beverage can 318. In this variation, the sleeve construct 300 again can have a first advertisement 320 on its exterior surface in the sleeve configuration and a second advertisement 325 can be provided on the surface of the assembled building block 310 as shown in FIG. 11D. The block 310 can be any suitable size and again has studs 326 and stud-receiving openings 328.

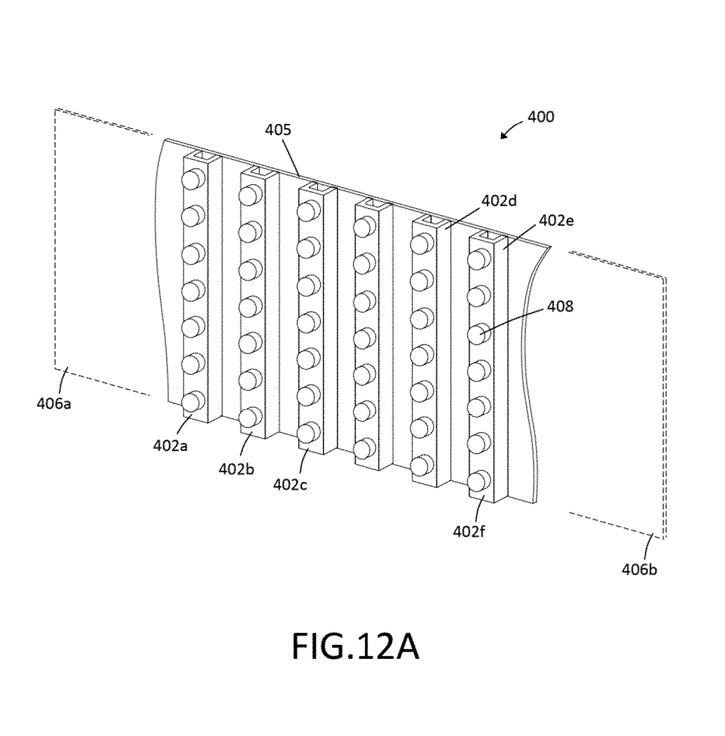

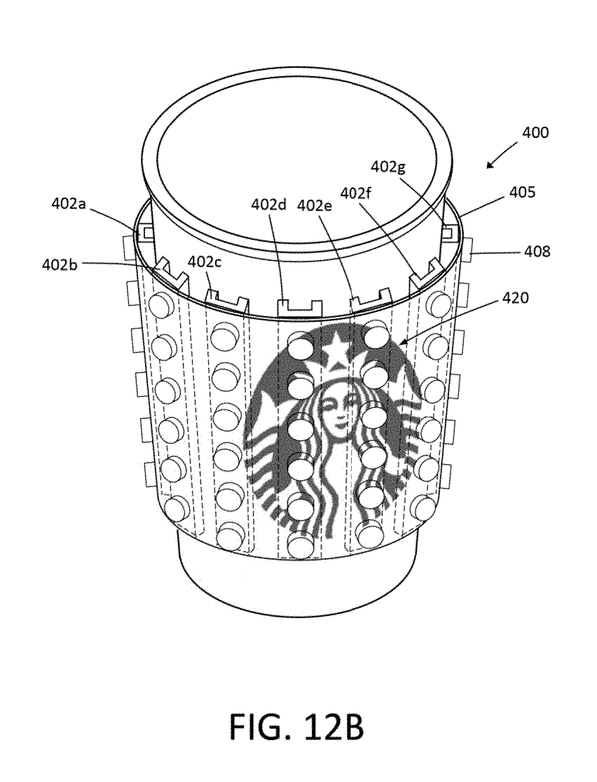

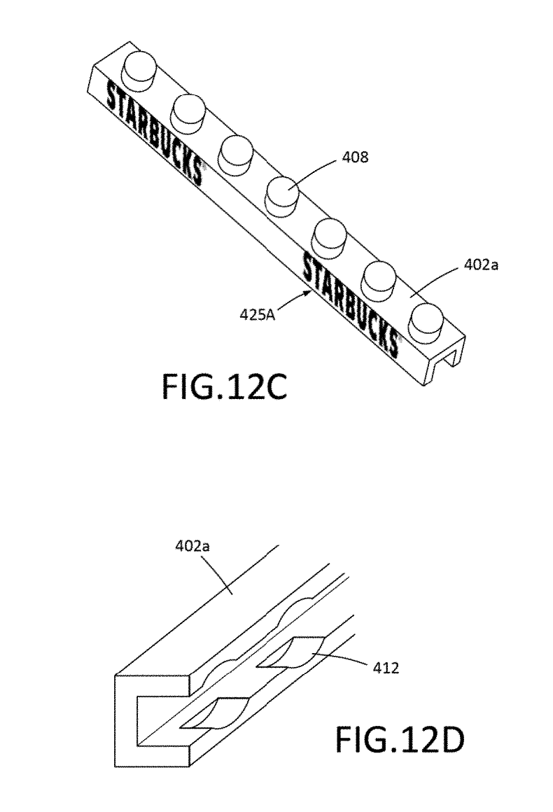

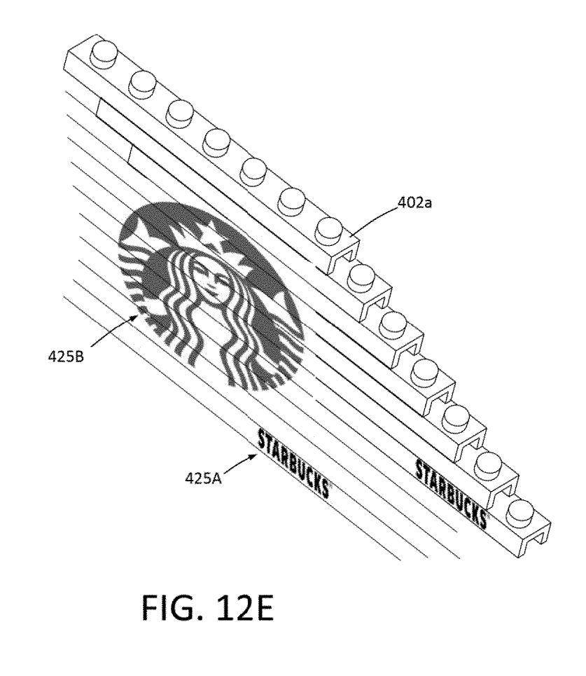

FIGS. 12A-12E illustrate another variation of transformable sleeve 400 wherein a plurality of molded plastic toy building blocks 402a-402g (in view) and assembled together with a thin detachable backing material 405 to provide an insulating coffee sleeve. Referring to FIG. 12A, it can be understood that the opposing ends 406a, 406b of the thin backing material 405 can be adhered to one another to provide the cylindrical or conical form of sleeve 400 shown in FIG. 12B. In one variation shown in FIG. 12A it can be seen that blocks 402a-402g can have studs 408 facing away from backing material 405 or the studs 408 can face toward and through openings in the backing material 405 as shown in FIG. 12B. Either configuration would assist in limiting heat transfer through the sleeve 400 to a user's fingers.

FIG. 12C illustrates an exemplary building block 402a separated from the backing sleeve 405. FIG. 12D shows the underside of block 402a in which receiving features 412 are provided to receive the studs 408 of another block.

In FIG. 12B, it can be seen that the construct has a first advertisement 420 on its exterior surface in the coffee sleeve configuration 400. FIG. 12E illustrates that the surface of the building blocks can have a second advertisement. In one variation, each block can carry an advertisement, such as text or an image indicated at 425A. An alternative advertisement 425B can be partly displayed on an individual block, with the full image of the advertisement displayed by an assembly of a plurality of blocks. Thus, the blocks could function as a puzzle wherein the user would need to use puzzle-solving skills to assemble the blocks to make the advertisement viewable in its entirety.

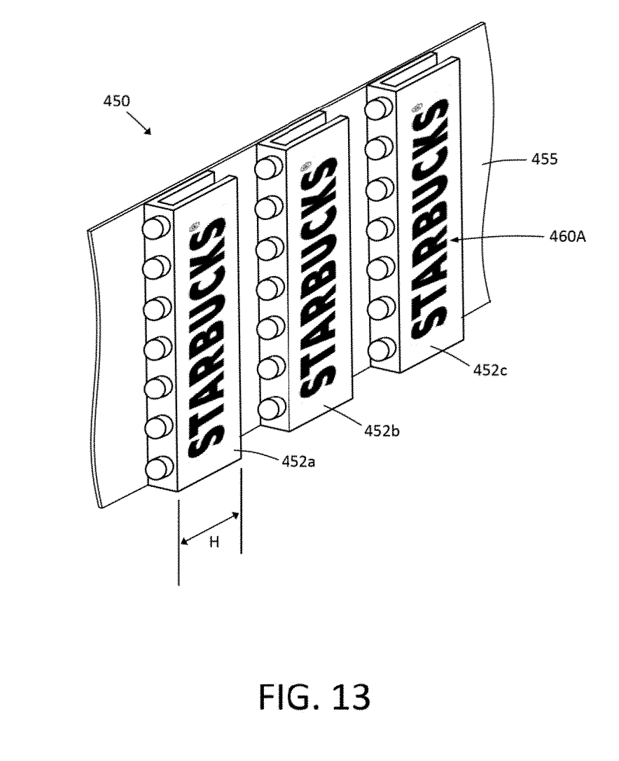

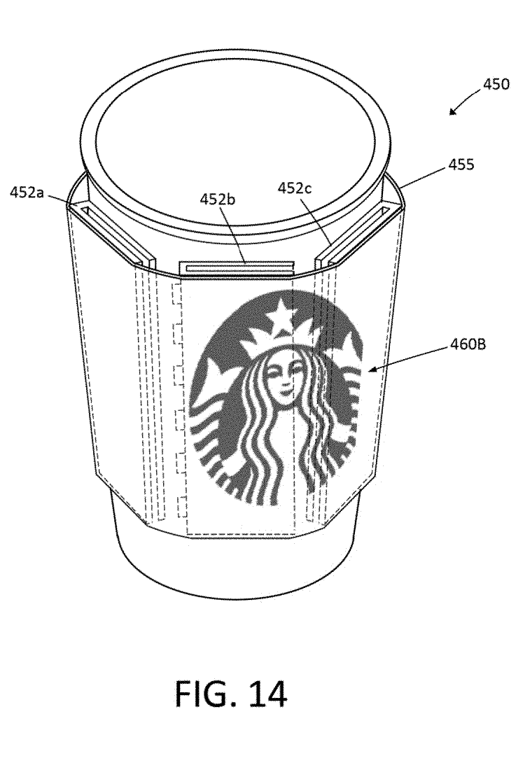

FIGS. 13-14 illustrate another variation of transformable advertising construct 450 having a sleeve shape or configuration and a non-sleeve configuration. In the sleeve shape of FIG. 13, the construct 450 can carry a plurality of molded plastic toy building blocks 452a-452c which are detachably coupled to a thin panel or backing material 455 to again provide a shape for receiving a beverage container. Referring to FIG. 13, it can be seen that the building blocks are a have height H that can be from 2 mm to 30 mm to provide a large surface for carrying a visual image 460A for advertising. The sleeve shape of the advertising construct 450 as shown in FIG. 14 can carry from about 1 to 50 building blocks. FIG. 14 further shows a second visual image 460B on the exterior of the construct 450 when in the sleeve shape. As can be seen in FIGS. 13-14, the blocks 452a-452c have studs 468 that provide for engaging one block to another as described previously. In this variation, the blocks also can have at least one curved surface (not shown) for fitting tightly against the wall of a beverage container and assembling a plurality of blocks together can result in a thin curved wall.

In another embodiment or advertising construct similar to that of FIGS. 11A-11B and FIGS. 13-14, the panel and/or the components of the modular toy can include a reservoir containing a fluid media or substance that is adapted to cool or heat the beverage container. In one embodiment, the construct can carry a coolant fluid that can be pre-cooled in a refrigeration device and then disposed around the beverage container.

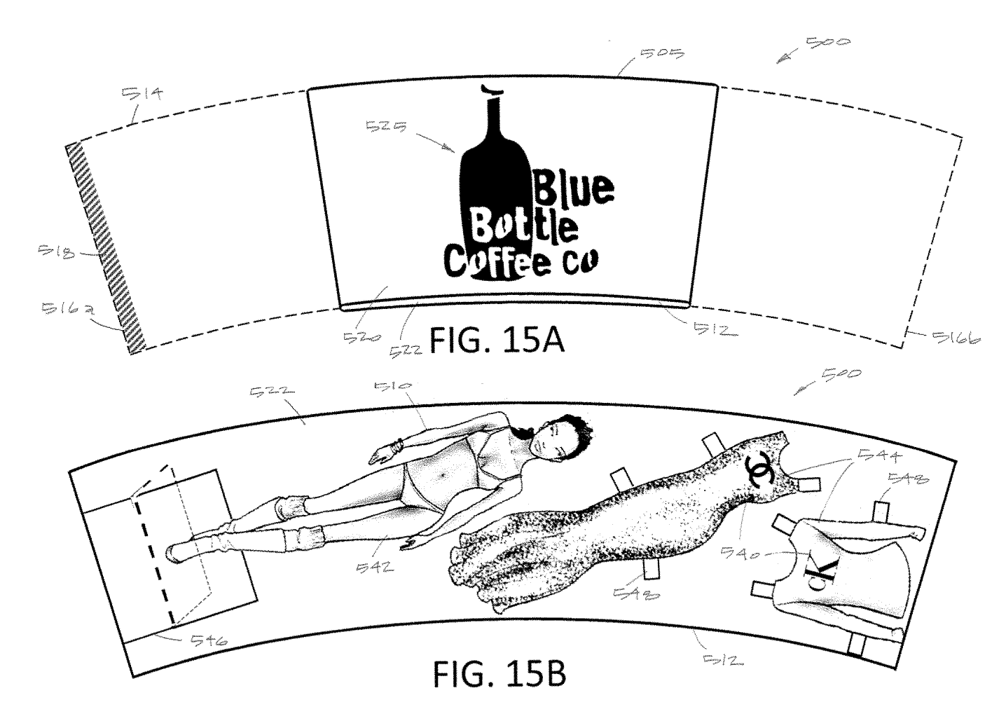

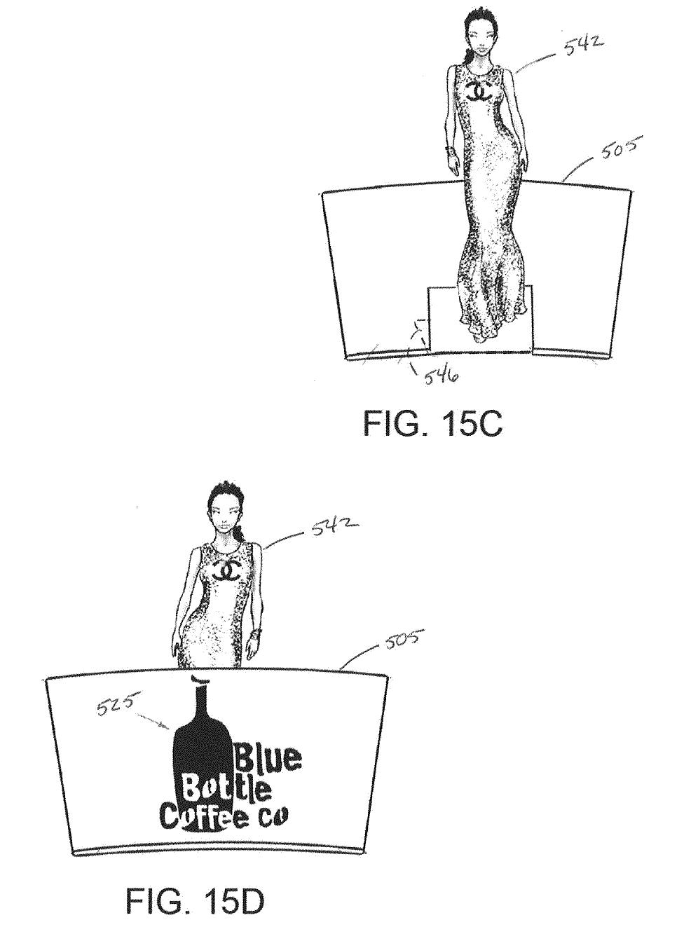

FIGS. 15A-15B illustrate another variation of transformable advertising construct 500 having a sleeve form 505 or configuration and a non-sleeve form or toy form 510 (FIG. 15B). In the sleeve form of FIG. 15A, it can be seen that a panel or thin material 512 has a flattened shape 514 (phantom view) with edges 516a and 516b that after folding can be bonded along adhesive line 518 to provide the sleeve form 505. In FIG. 15A, the construct 500 has a first side 522 and a second side 520 wherein said second side 520 comprises an outer surface of the thin material 512 in the sleeve form 505 that is visible when used as a beverage sleeve. The first side 522 is the opposite side of the thin material 512. As can be seen in FIG. 15A, the second side 520 carries a message in the form of a graphical image that can provide information, graphics, and/or advertisement 525 which, in the illustrated example, is shown as a coffee company logo. Now turning to FIG. 15B, the first side 522 of the thin material 512 is shown as when the sleeve form 505 has its ends 516a and 516b detached and the thin material 512 is flattened. The first side 522 can be adapted to the non-sleeve or toy form 510 that can carry a second message, information or advertisement 540. In this variation, the toy form 510 consists of one or more folding toys, and more particularly a paper doll or figurine 542 and accessories 544 that carry the message, information or advertisement 540 which in this instance is a clothing company logo. The message can include, for example, at least one of a name, initials, logo, image, trademark, tag line, color arrangement, symbol, letter, address, website, numerical message, text message, hashtag, puzzle or cryptogram.

In the variation of FIG. 15B, the figurine 542 and accessories 544 can have edges that are perforated in the thin material 512 to allow for tear-away from the remainder of the thin material or the edges can be designed for cutting with a scissors or knife blade. Alternatively, on or more of the toy form 510 can be disposed on the thin material 512 or on a detachable paper layer coupled to the thin material. In the variation of the toy form 510 shown in FIG. 15B, the figurine 542 has a folding base 546 to make a stand for the figurine and the accessories 544 have folding tabs 548 for coupling to the accessories to the figurine.

FIGS. 15C and 15D also illustrate a variation of a construct 500 where the toy form from FIG. 15B is coupled to the sleeve form 505 to produce a display shape. Alternatively, the toy form 542 can be positioned alone with the folding base 546 allowing for the toy form 542 to provide a display shape. In the illustrated example, the second graphical image of the toy form 542 (comprising the images discussed above) provides a display shape (i.e., the finished shape of the toy form 5420 standing alone or coupled to the portion of the construct 500/sleeve 505) allows for display of the first graphical image and the second graphical image simultaneously. In the illustrated example of FIG. 15C, the advertisement 525 is visible on the opposite side of the sleeve shape 505. In 15D, the advertisement 525 and toy form 542 are visible on the same side.

As shown, the accessories 544 can also be graphical images that are detachable from the construct 500 and configured to be joined to the display shape (the finished shape of the toy form 510 standing alone or coupled to a portion of the construct.) As shown in FIGS. 15C and 15D, the construct can remain in the sleeve shape prior to deforming or detaching the support portion and/or graphical image from the construct. Alternatively, as discussed above, the construct can be deconstructed from the sleeve shape such that the graphical image is transformed into a display shape.

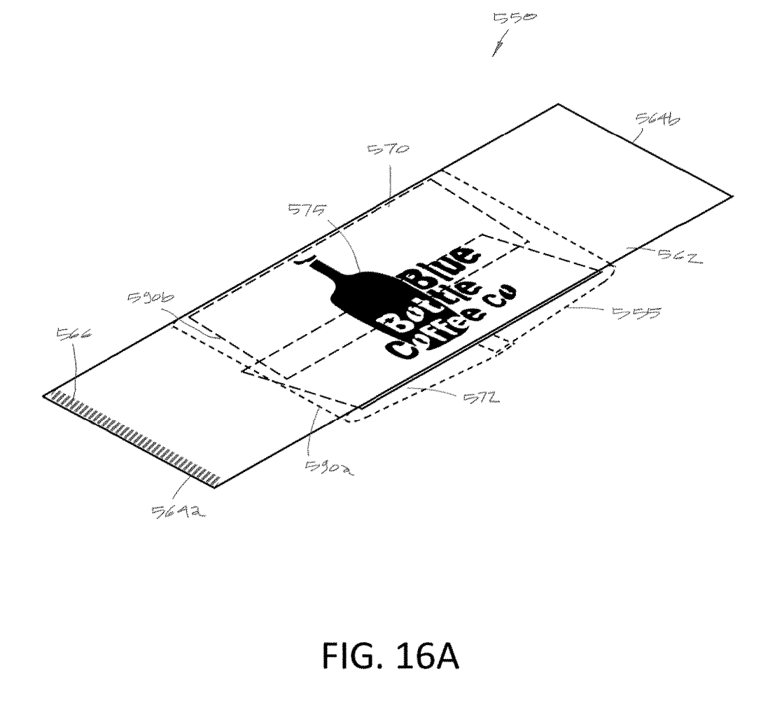

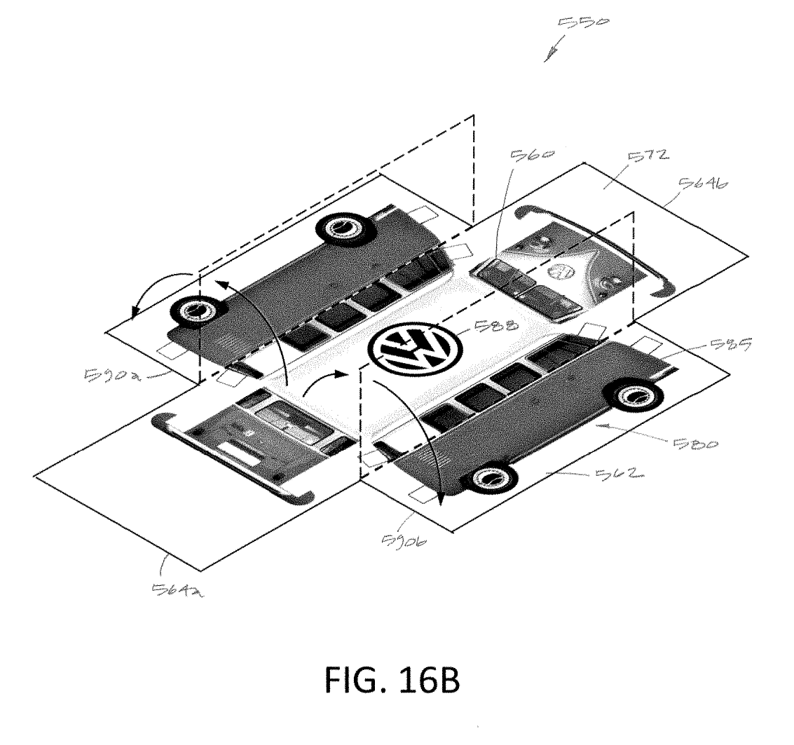

FIGS. 16A-16B illustrate another variation of transformable advertising construct 550 that is similar in principle to that of FIGS. 15A-15B with a sleeve form 555 and a non-sleeve form (FIG. 16A) or toy form 560 (FIG. 16B). The sleeve form 555 of the construct 550 is shown in phantom view in FIG. 16A as when the thin material 562 is folded and the ends 564a and 564b are attached to one another along adhesive line 566. The construct 550 has a first side 572 (FIG. 16B) and a second side 570 (FIG. 16B) wherein said second side 570 in FIG. 16A comprises an outer surface of thin material 562 in the sleeve form 555 that is visible when used as a beverage sleeve. The first side 572 is the opposite side of the thin material 562 as shown in FIG. 16B. As can be seen in FIG. 16A, the second side 570 carries a message, information or advertisement 575 which is again shown as a coffee company logo.

FIG. 16B shows the first side 572 of the thin material 562 when the sleeve form 555 has its ends 564a and 564b detached and the thin material 562 is flattened. The first side 572 then makes visible the non-sleeve or toy form 560 that carries a message, information or advertisement 580. The message can be the same or different as the first side and is generally a graphical image. In this variation, the toy form 560 again consists of a folding toy, and more particularly a foldable vehicle 585 which can be an advertisement in itself. Alternatively, the toy form 560 can carry a logo 588 or other message. In this variation, the toy form 560 includes thin fold-out wings 590a and 590b that provide additional foldable structure for the toy form 560. The toy form 560 of FIG. 16B may have perforated, tear-away edges or edges designed for cutting with a scissors from the thin material 562.

While the construct variations of FIGS. 15A-15B and 16A-6B illustrate paper dolls and vehicles, it should be appreciated that other images or foldable toy forms may be suitable for carrying information or an advertisings messages, such as paper buildings, aircraft, watercraft, spacecraft, trains, animals, trees, plants, flowers and the like.

In general, a method for distributing information to consumers corresponding to the invention comprises providing a message carrying construct, wherein the construct is transformable from a first form configured as a sleeve for a beverage container and a second form configured as a toy, distributing the construct to a consumer for use with a beverage container, displaying first information on a first surface of the construct in said first sleeve form and thereafter displaying second information on a second surface of the construct in said second toy form.

In the foregoing description, certain specific details are set forth in order to provide a thorough understanding of various embodiments. However, one skilled in the relevant art will recognize that the embodiments may be practiced without one or more of these specific details, or with other methods, components, materials, etc. Unless the context requires otherwise, throughout the specification and claims which follow, the word “comprise” and variations thereof are to be construed in an open, inclusive sense, that is as “including, but not limited to.”

Reference throughout this specification to “an embodiment” or “variation” means that a particular feature, structure or characteristic described in connection with the embodiment is included in at least one embodiment. The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of this disclosure, as will be recognized by those skilled in the relevant art.

In general, in the following claims, the terms used should not be construed to limit this disclosure to the specific embodiments disclosed in the specification and the claims, but should be construed to include all advertising constructs that can operate in accordance with the claims. Accordingly, the embodiments are not limited by this disclosure, but instead their scope is to be determined entirely by the following claims and equivalents thereof.

1.-11. (canceled)

12. A method for conveying information with a consumer, the method comprising:
providing a sleeve construct for positioning about a beverage container such that a first side of the sleeve construct engages the beverage container, and a second side of the sleeve construct is opposite to the first side and allowing for engagement by the consumer during handling of the beverage container, where the first side comprises a first graphical image, and where the second side comprises a second graphical image; and
positioning the sleeve construct about the beverage container such that the first graphical image is obscured by the beverage container and the second graphical image is not obscured by the beverage container until the consumer modifies at least a portion of the sleeve construct and deforms or detaches a portion of the sleeve construct from a remainder of the sleeve construct to form a self-supporting display shape that allows for viewing of the first graphical image.

13. The method of claim 12, wherein the first graphical image is different from the second graphical image.

14. The method of claim 12, wherein the sleeve construct comprises a flat material.

15. The method of 14, where the sleeve construct is configured such that modifying the flat material includes at least one of the steps of detaching, folding, bending, cutting or assembling said material or a portion thereof.

16. The method of claim 12, wherein the first graphical image and the second graphical image are selected from a group consisting of: a picture, name, initials, logo, image, trademark, tag line, color arrangement, symbol, letter, address, website, numerical message, text message, hashtag, puzzle and cryptogram.

17.-28. (canceled)

29. The method of claim 12, where the self-supporting display shape is configured to allow viewing of the first graphical image and the second graphical image simultaneously.

30. The method of claim 12, where the self-supporting display shape comprises a toy form.

31. The method of claim 12, where the first graphical image comprises a plurality of first graphical images.

32. The method of claim 12, where at least one of the plurality of first graphical images is detachable from the construct and configured to be joined to the display shape.

33. The method of claim 12, further comprising distributing the sleeve construct and beverage container to a consumer.
